(19) United States
(12) Patent Application Publication
(10) Pub. No.: US 2016/0232631 A1
(43) Pub. Date: Aug. 11, 2016

(54) REPAYMENT THROUGH NON RECOURSE CONTRACTS RELATED TO LITIGATION

(71) Applicant: TIMOTHY J. YOUNG, NEW ORLEANS, LA (US)

(72) Inventor: TIMOTHY J. YOUNG, NEW ORLEANS, LA (US)

(21) Appl. No.: 15/133,742

(22) Filed: Apr. 20, 2016

Related U.S. Application Data
(63) Continuation-in-part of application No. PCT/US15/48560, filed on Sep. 4, 2015.
(60) Provisional application No. 62/175,508, filed on Jun. 15, 2015.
(60) Provisional application No. 62/149,764, filed on Apr. 20, 2015.
(60) Provisional application No. 62/102,652, filed on Jan. 13, 2015.

(51) Int. Cl. G06Q 50/18; G06Q 40/02; G06Q 40/08

(52) U.S. Cl. CPC G06Q 50/18; G06Q 40/08; G06Q 40/02

(57) ABSTRACT

The invention provides for a contract to serve lending industries to cover litigation related loans. More particularly the invention is a computer method that protects against the risk of financial losses of non-recourse litigation loans through: forming by a contract; forming a first market participant providing for a contingency payment electronically triggered by the occurrence of a credit event of a reference entity; forming a second market participant; requesting the second market participant to provide a premium payment in exchange for the contingency payment electronically triggered by the occurrence of the credit event; initiating a trade between the first and the second market participant; and determining the occurrence of the credit event; calculating the value of the contract and transferring to the second market participant a sum of money equivalent to the value of the contract.

### CROSS-REFERENCE TO RELATED APPLICATIONS

This application claims priority under 35 U.S.C. §120 of international non provisional patent application, PCT/US 15/48560, filed Sep. 4, 2015, entitled System And Method For Insuring Against Unrecoverable Litigation Costs, which claims the benefit of provisional patent application Ser. No. 62/102,652, filed on Jan. 13, 2015, and under 35 U.S.C. §119(e) of U.S. provisional patent application Ser. No. 62/175,508, filed Jun. 15, 2015, entitled System And Method For Insuring Against Unrecoverable Litigation Costs, and priority under 35 U.S.C. §119(e) of U.S. provisional patent application Ser. No. 62/149,764, filed on Apr. 20, 2015, entitled Repayment Through Credit Swap of Non Recourse Loans Related To Litigation, and priority under 35 U.S.C. §119(e) of U.S. provisional patent application Ser. No. 62/102,652, filed on Jan. 13, 2015, entitled, Credit Default Swap And Electronic Trading System, For Protection Of Litigation Costs, the entire disclosures of each of the foregoing, which are hereby incorporated by reference.

### FIELD OF INVENTION

The present invention relates generally to creation, query and retrieval of information both on the web and on internal servers, and more particularly a method for conducting the electronic reimbursement for expenses of litigation through a specialized financial instrument.

### BACKGROUND

Certain lenders offer non recourse loans to litigants during the pendency of their lawsuits to fund the various stages and tasks that require out of pocket expenses. Such companies include, but are not limited to, Lighthouse Legal, Oasis, and others. If the litigant in receipt of such a loan (“the debtor”), succeeds in receiving an award of money damages at the conclusion of the lawsuit, the debtor is obligated to repay the loan to the lender with usually high rates of interest. In the event that there fails to be an award of money damages sufficient to repay the loan, the lender is in most instances is unable to collect the outstanding loaned amount, because the loans are non recourse.

Historically in the United States, legal claims take years to work their way through the judicial system. Often the litigants have suffered serious personal injuries, or at times business damages, which make it difficult for the individual or business to forego any compensation until the conclusion of the litigation. Therefore, many lenders offer such litigants non recourse loans for medical expenses, living expenses or even business expenses to be used during the litigation. These loans are typically high risk loans, as the likelihood of success of the litigation is unknown. Moreover, many of the borrowers have few assets to repay the loans, beyond the recovery which may be received through the litigation. Therefore, the lenders charge high rates of interest to compensate for the risk of the loans. Such high rates allow the lenders to adjust for the losses, which occur by generating high rates of returns on the successful loans. Currently, there is no means for these lenders to hedge their loan loses other than adjusting their interest rates upward to compensate for such losses.

A credit default swap (CDS) is a particular type of swap designed to transfer the credit exposure of fixed income products between two or more parties, i.e., hedge. In a credit default swap, the buyer of the swap makes payments to the swap's seller up until the maturity date of a contract. In return, the seller agrees that, in the event that the debt issuer defaults or experiences another credit event, the seller will pay the buyer the security's premium as well all interest payments that would have been paid between that time and the security's maturity date. A credit default swap is a financial swap agreement that the seller of the CDS will compensate the buyer (usually the creditor of the reference loan) in the event of a loan default (by the debtor) or other credit event. In the context of the present invention, the credit event is a judgment or settlement in a litigation case, the amount of which is insufficient to pay the litigation costs and expenses. This is to say that the seller of the CDS insures the buyer (a litigator) against some default, such as a case that does not produce a monetary judgment, sufficient to pay litigation costs and expenses. The buyer (i.e., a litigator) of the CDS may make a series of payments (the CDS “fee” or “spread”) to the seller and, in exchange, receives a payoff, if the judgment is insufficient to pay litigation costs and expenses.

Thus, what is needed is a system for the creation of a hedging instrument, and a method and system for its pricing and implementation, which essentially serves as a repayment of non recourse loans regardless of the outcome of a case, and whether the litigant has sufficient funds following litigation, to repay the loan. More particularly, what is needed is a method and system for reimbursing lawyer litigation costs and expenses pursuant to a hedging instrument; assessing the reimbursement claim, based on automatic document comparisons and electronic triggering of critical events; adjusting the claims; and the electronic processing of reimbursement claims and payments thereunder.

### SUMMARY OF THE INVENTION

The invention relates to a computer system for protecting against the risk of financial losses of loans for litigation financing and includes one or more network interfaces; at least one processor; a memory; and computer program code stored in a computer readable storage medium, executable by at least one processor: comprising: (a) a first computer interface to post a first participant credit default swap (CDS) contract terms and conditions of a contingency payment related to a litigation case being offered and a credit event as defined by the first participant; (b) a second computer interface for allowing the first participant to post the requested premium for the CDS contract; (c) a third computer interface for allowing for a second market participant to view the posted premium, and request a CDS contract be offered at the posted premium; (d) a fourth computer interface for allowing the first participant to offer said CDS contract to the second participant at said posted premium; (e) a match engine for executing the CDS contract between the first and the second participant; (f) an electronic indicator that signals a change in the litigation case status received by a database litigation file; (g) a comparator, which compares the database litigation file data to a litigant contracts database, such that if the comparison matches then, executable code determines if the litigation case has terminated and if a payment under the CDS contract terms and conditions of a contingency payment related to a litigation is due.

The invention also relates to a computer system for protecting against the risk of financial losses of loans for litigation financing and includes one or more network interfaces including at least one processor; at least one memory; and a computer program stored in a computer readable storage medium, executable by at least one processor further including: (a) a first computer interface to post a first participant credit default swap contract terms and conditions of a contingency payment related to a litigation case being offered and a credit event as defined by a first participant; (b) a second computer interface for allowing the first participant to post a requested premium for the credit default swap contract; (c) a third computer interface for allowing for a second market participant to view the posted premium, and request a credit default swap contract be offered at the posted premium; (d) a fourth computer interface for allowing the first participant to offer said credit default swap contract to the second participant at said posted premium; (e) a match engine for executing the credit default swap contract between the first and the second participant; (f) a crawler to update a litigation database containing the cases pertinent to the credit event; (g) an electronic indicator that signals a change in the litigation case status received by a database litigation file; (h) a comparator, which compares the database litigation file data to a litigant contracts database; (i) a register for setting a flag, if the comparison matches, (j) a processor to execute code to determine if the litigation case has terminated and if a payment under the credit default contract terms and conditions of a contingency payment related to the litigation is due.

The system in one form includes a computer system having application specific circuits or processors for testing, comparing, setting control values related to determining if a payment is due. Further, in addition to specialized circuits, processors the invention includes programs to determine the actuarial data and associated risks of particular non recourse loans; programs to associate three (3) parties: (a) the litigant, (b) the lending institution, and (c) the guarantor of a CDS contract for the repayment of the loan, under certain conditions of non repayment by the litigant, or the lawyer representing the litigant; and programs to automatically determine the price of the loan.

In one embodiment of the invention, a CDS contract is offered for sale, backed by a protection seller, typically through a broker or a trading system. The purchaser of the contract is a lending institution, to insure that it is repaid the debt of its lender (or a portion of it) upon the conclusion of the lawsuit.

A litigant executes a non-recourse loan document, or series of loan documents, to borrow money during the pendency of their litigation. Under one embodiment of the invention, embedded within such loan documents would be the express agreement by the litigant to allow the lender to purchase the credit protection CDS, with such purchase price being added to the loan price as a fee or portion of the interest.

Under another embodiment of the invention, the lenders may simply purchase the CDS protection without regard to any authorization or involvement of the underlying litigant borrower. Under this embodiment, the invention would serve as a separate, note independent, risk hedge for litigation lenders to use to offset the potential losses on their litigation loan pools. Hedge funds making litigation loans may find this embodiment advantageous as a means to hedge the risk associated with such loan portfolios.

The invention may be sold off by creating pools and tranches of litigation loans similar to those that currently exist in the mortgage pool industry. Under one embodiment of the invention the bank may elect to provide the litigant/client and attorney with credit for any monies ultimately received from the CDS in the event of the specific credit event, however such bank need not do so under yet another embodiment of the invention.

In yet another embodiment of the invention a computer program includes an interface embodied on a computer readable medium for protecting against the risk of financial losses of loans in litigation further including: (a) a first computer interface to post a first participant CDS contract terms and conditions of a contingency payment being offered and a credit event as defined by the first participant; (b) a second computer interface for allowing the first participant to post the requested premium for the CDS contract; (c) a third computer interface for allowing for a second market participant to view a posted premium, and request a CDS contract be offered at the posted premium; (d) a fourth computer interface for allowing the first participant to offer said CDS contract to the second participant at said posted premium; (e) a match engine for executing the CDS contract between the first and the second participant.

In yet another embodiment of the invention, a computer method searches and retrieves documents in a computer network to pay a non recourse loan including: (a) receiving from a user, through an input device, a query for a non recourse loan; guiding the user through a series of graphical user interface queries to supply information to a database about a litigation case; (b) processing the query to extract one or more of: an identity of a litigant, type of litigation case, a range of economic damages, name of insurance carriers, type of coverage; (c) the non recourse contract amount, an estimate of the time to conclude the case, a court in which the case resides, an estimate of litigation success; performing an actuarial analysis based on one or more of: the identity of a litigant, type of litigation case, the range of economic damages, name of insurance carriers, type of coverage; (d) the non recourse contract amount, the estimate of the time to conclude the case, the court in which the case resides, the estimate of litigation success; (e) performing a search of an electronic data base, using the terms of the contract, to find a contracting party offering a non recourse contract; (f) calculating a contract premium to be paid for a non recourse loan coverage of the standard contract; obtaining a search result in the form of one or more site names, universal resource locators, web pages and documents having descriptions of one or more loan entities satisfying search criteria offering the non recourse contract terms; (g) displaying the search results to the user; (h) selecting one of the loan entities; (i) purchasing the selected loan entity contract by the user; utilizing a crawler to monitor the litigation case progress; (j) utilizing one or more of an application specific processor or executable computer code, to determining if a previous litigation case document has changed from a current litigation document; (k) wherein the change produces an electronic indicator signal if the litigation case status occurs; and (l) comparing the database litigation case that produced the electronic indicator signal, to a litigant contracts database containing a related litigation case, such that if the comparison matches then, the comparator stores a flag in a register; (m) reading the flag by the processor that executes computer code to test if an insured is entitled to a sum of money equivalent to the value of an insured interest.

In yet another embodiment the system and method permits the seller to verify the status of a lawsuit utilizing state and federal data lawsuit bases, such as accessing the federal computer system known as PACER, which provides on-line access to U.S. Appellate, District, and Bankruptcy court records and documents nationwide

The invention also relates to a litigation loan and associated debt instrument, creation and repayment system and process. In order to facilitate such an invention, an electronic trading system ensures a pricing model for the debt instruments, a means for exchange and generation of a contract, i.e., a CDS instrument (also, referred to as a credit default swap, CDS contract, or simply a “CDS”) between the lenders of litigation loans and the sellers of protection (or hedges) against the risk of such loans.

### BRIEF DESCRIPTION OF THE DRAWINGS

FIG. 1 is a block diagram of a system for creating, exchanging, determining the value of, and settlement of, the CDS invention, in accordance an embodiment of the present invention.

FIG. 2 is a flowchart of the steps in a method of creating, exchanging, determining the value of, and settlement of, the CDS contract, in accordance an embodiment of the present invention.

FIG. 3 is a block diagram of a system for creating, exchanging, determining the value of, and settlement of a CDS contract, in accordance an embodiment of the present invention;

FIG. 4 is a block diagram of a system interface for creating, exchanging, determining the value of, and settlement of a contract, in accordance an embodiment of the present invention;

FIG. 5A shows a screen for inputting data into the invention system in accordance with an embodiment of the present invention;

FIG. 5B shows a screen for inputting data into the invention system in accordance with an embodiment of the present invention.

### DETAILED DESCRIPTION OF THE INVENTION

In the figures to be discussed the blocks and arrows represent functions of the process according to embodiments of the present invention which may be implemented as computers, computer executable code, and/or electrical circuits and associated wires or data buses, which transport electrical signals. Alternatively, one or more associated arrows may represent communication (e.g., data flow) between software routines, particularly when the present method or apparatus of the present invention is implemented as a digital process.

In CDS instruments certain terms must be defined. These terms include what triggers or constitutes the ‘credit event’ or ‘reference event’ (hereinafter ‘credit event’ for consistency), the ‘credit exposure’, ‘valuation metrics’ and ‘maturity’. The credit event is the specified event which triggers the obligation of the protection seller to pay the protection buyer under the contract. The credit exposure is the amount of risk undertaken by the protection seller and purchased by the protection buyer. The valuation metrics is the method by which the payout amount due from the protection seller to the protection buyer is calculated. Maturity is defined as when the credit event occurs or when the underlying case is terminated through a full dismissal without the occurrence of a credit event, whichever occurs first.

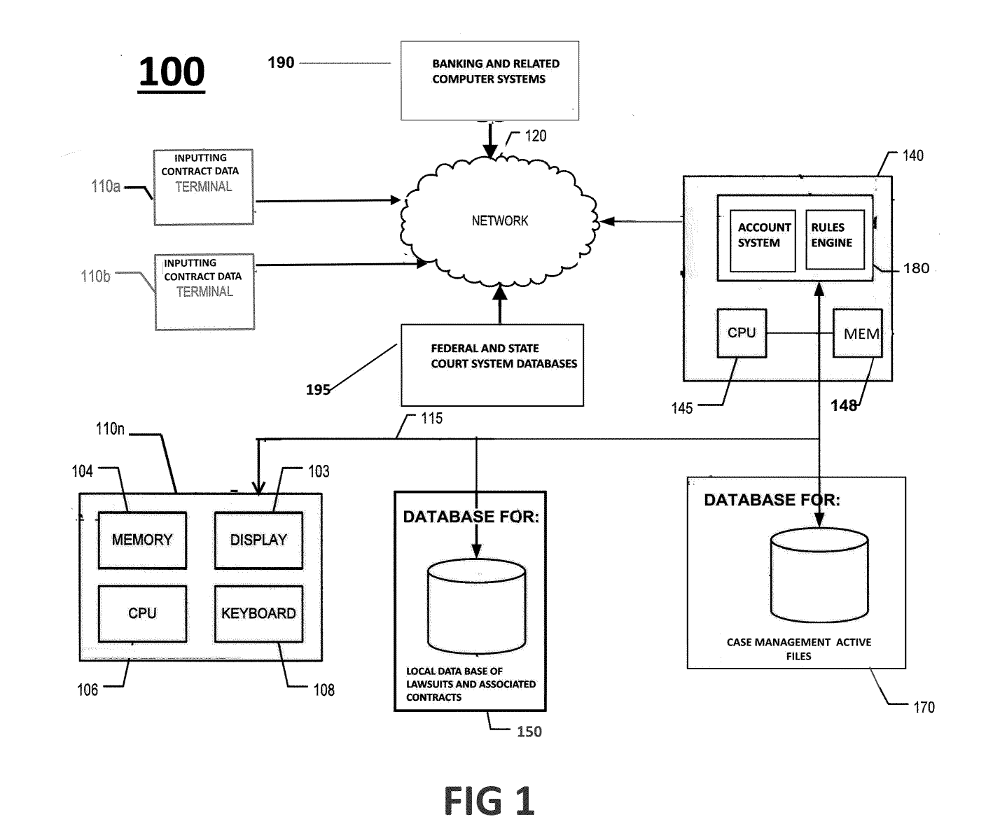

In one embodiment of the invention, an electronic computer trading system, such as described in FIG. 1, is created to facilitate the trading and payment of such CDS contracts. The system allows for each buyer to log into a terminal 110(a), 110(b), utilizing keyboard 108, proving a private secure electronic means to input their requests for a CDS and later to view the current contracts they may have in place. At the central site the seller logs into terminal 110(n) to administrate and to view all data and contracts on a global basis. The system 100 allows each logged in buyer to request a premium quote for a specified CDS contract. Further it allows each logged in buyer to input data such that the premium quote may be generated automatically, with such data including the underlying case reference against which the hedge is sought and the notional value (or maximum payout value) is sought. The system allows for the automatic computer generation of the contract premium referenced above by electronically pulling certain data factors, all available within the computer system including, but not limited to, the total notional value of all CDS contracts outstanding, the estimated maturity dates for all such contracts based on certain assumptions as to the length of each contract, and the historical credit event occurrence rate; allows for the generation of invoices for the payment of CDS contract premiums. System 100 further allows for the generation of invoices for the payment to buyers in the event of credit events. It further allows for the uploading of all required documentation including case documentation complaints and original filings and original signed confirmations of each CDS contract and allows for the automatic generation of contract confirmations, which are then signed by the buyer (e.g., the lender) and seller (guarantor of the CDS), by pulling data from the system including the buyer's information, the case reference subject to the contract, the input notional value of the contract and the automatically calculated CDS premium for such contract. In the event tranches or pools of loans are used, then such information may also be included in the valuation metrics. It further allows for the printing of key documentation underlying all CDS contracts by both buyer and seller. In one embodiment, the system 100 permits the CDS seller to verify the status of a lawsuit utilizing state and federal data bases. This is achieved by accessing the federal computer system 195, known as PACER (see, http://www.pacer.gov). The computer system 100 also allows for an API to be created which would allow buyers to export certain data into their computer systems for data management outside of the invention computer system.

In general, FIG. 1, system 100 includes a network, such as a local area network (LAN) of terminals or workstations, database file servers, input devices (such as keyboards and document scanners) and output devices configured by software (processor executable code), hardware, firmware, and/or combinations thereof, for accumulating, processing, administering and analyzing the present system and method for accounting for and paying expenses associated with lawsuits, more particularly, CDS terms and conditions of one or more contingency payments associated with said lawsuits. The system provides for calculating the CDS premiums or contract costs for a designated lawsuit, notifying the person, who may be the beneficiary of funds (such as the lending institution of the non recourse loan) to offset the expenses associated with a lawsuit of the amount of funds and timing of the expected payout. This advantageously results in reduced financial risks, reduced associated with prosecuting or defending an associated lawsuit. System 100 additionally provides for electronic data transfer pertaining to administrative data, and billing relating to the novel system and method disclosed herein.

The features of system 100 may be implemented in a system of computer peripherals that communicatively couple to over various types of networks, such as a wide area networks and the global interconnection of computers and computer networks commonly referred to as the Internet. Such a network may typically include one or more microprocessor based computing devices, such as computer (PC) workstations, as well as servers. “Computer”, as referred to herein, general refers to a general purpose computing device that includes a processor. “Processor”, as used herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., software, programs or code) from memory and decodes and executes them, calling on the ALU when necessary. “Memory”, as used herein, refers to one or more devices capable of storing data, such as in the form of chips, tapes, disks or drives. Memory may take the form of one or more media drives, random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including a processor or a computer.

The term “server,” as used herein, generally refers to a computer or device communicatively coupled to a network that manages network resources. For example, a file server is a computer and storage device dedicated to storing files, while a database server is a computer system that processes database queries. A server may refer to a discrete computing device, or may refer to the program that is managing resources rather than an entire computer.

In FIG. 1, other hardware configurations may be used in place of, or in combination with software code to implement an embodiment of the invention. For example, the elements illustrated herein may also be implemented as discrete hardware elements. As would be appreciated, the inventive system described herein terminals for inputting contract data and paying out contracts when due, such as 110a, 110b, and server 130, server 140 and the associated databases 150, 170 as may be embodied in a general purpose or special purpose computing system.

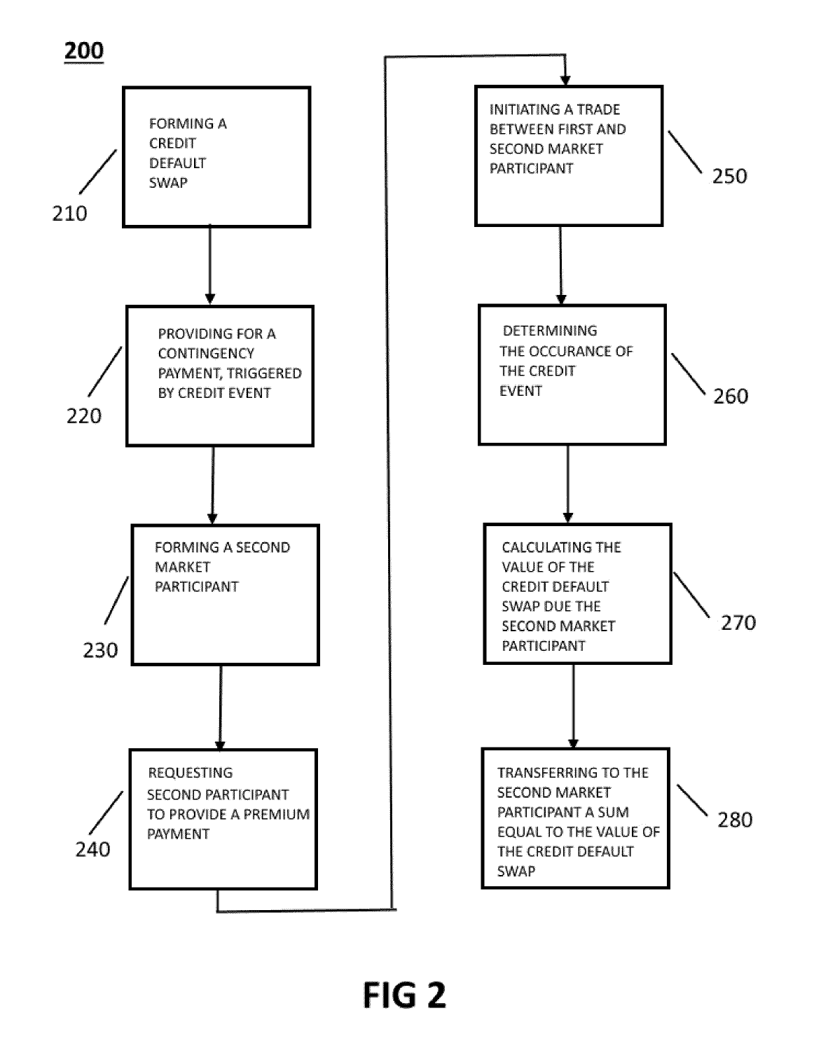

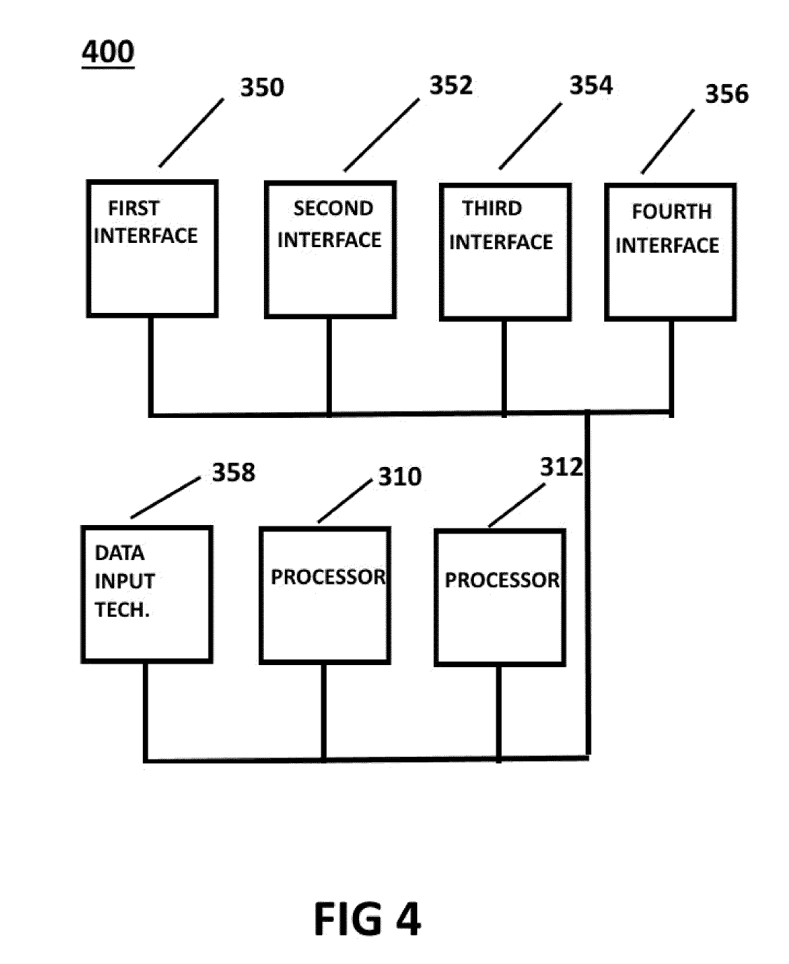

The system or parts thereof may be a embodied in a special hardware configuration, such as a dedicated logic circuit, integrated circuit, Programmable Array Logic (PAL), Application Specific Integrated Circuit (ASIC), that provides known outputs in response to known inputs to provide among other things, for the contingency payment electronically triggered by the occurrence of a credit event 40 (see, FIG. 2, 40 and FIG. 4B, 358).

FIG. 1 system 100 and processors 140 and 106, incorporate elements of the process 200 shown in FIG. 2, within each processor, as embodied on a computer readable medium for protecting against the risk of financial losses of case expense costs in litigation. As further shown in FIG. 2 the method of creating and administering a CDS contract having one or more contingency payments associated with said lawsuits includes: (a) forming 210 a first participant CDS contract having terms and conditions of a contingency payment; (b) providing 220 for a contingency payment to be made upon the occurrence of a credit event; (c) forming a second market participant 230; requesting the second market participant to prove a premium payment to the first market participant in exchange for the contingency payment electronically triggered by the occurrence of a credit event 240. A special processor or an Application Specific Integrated Circuit (ASIC), provides known outputs in response to known inputs, to provide among other things, whether two litigation documents reflect a change in the credit event and initiate a trigger for further examination of the documents as to whether an occurrence of a credit event 260 initiates a contingency payment.

The process further includes the step of initiating a trade between the first and the second market participant 250; (d) determining the occurrence of the credit event 260; and calculating the value of the CDS contract due to the second market participant 270; transferring to the second market participant a sum of money equal to the value of the CDS 280.

In one embodiment, system 100 and process 200 utilize a remote site system 110n configured with an accounting/bookkeeping software such as QuickBooks® Pro/Premier/Enterprise, or Microsoft® EXCEL, residing in memory 104, a database 150; a utility software resident in memory 104 to permit a central site computer web server 130 to receive from the remote site system 110n CDS contract data stored in database 150 at the remote site; and server 140 to read customer accounts either received from the web server 130 or residing in a database 170; an Internet connection 120 having a browser appearing on display 103. The central site includes web server 130 or alternatively a server 140 having conditioning software to parse, filter and generally extract pay out data received from system 110n; and a rules engine 180 customized to a particular type of lawsuit. Once the CDS contract premiums are determined, the premium amount due is transmitted through network 120 to a banking or billing system 190. The billing system 190 debits an account and credits a receivable account.

Communications represented by line 115, may be of wired and/or wireless type, to provide interconnectivity between payroll system 110n, database 150 and one or more networks 120, that may in-turn be communicatively coupled to the Internet, a wide area network, a metropolitan area network, a local area network, a terrestrial broadcast system, a cable network, a satellite network, a wireless network, or a telephone network, as well as portions or combinations of these and other types of networks (all herein referred to variously as a network or the Internet). Data is sent to and from the payroll system 110n and the server 130 via a FTP, a HTTP request or http post (collectively referred to herein as an “http post”). The exemplary browser based system 100 can function from any 128 bit (or higher) encryption enabled Internet enabled computer in the world equipped with a browser, such as by way of example and not limitation, MICROSOFT® INTERNET EXPLORER browser for the World Wide Web by Microsoft Corp. of Redmond, Wash.; or MOZILLA FIREFOX® by the Mozilla Corporation of Mountain View California.

Nevertheless, the inventive process 200 may also be practiced using other proprietary or non-proprietary network protocols, over other public and/or private computer networks. Further, although preferred embodiments include human-machine interface displays and applets that are capable of running in standard browsers, the invention may be practiced using native human machine interface applications that run directly under the host computers' operating systems (e.g., MICROSOFT® WINDOWS® operating system, UNIX® operating system, Apple™ operating system, LINUX® operating system and the like).

The browser-based system 100 for managing the CDS contract terms and conditions of a contingency payment determination system is accessible by a plurality of users such as law firms and corporate law offices, using participant client computers each equipped with a web-browser. Each participant can enroll in, research, monitor, and select courses of action at their own pace.

In the illustrated embodiment of system 100, server 140 is in communication with database 170 to store CDS contract terms and conditions of a contingency payment information, contract cost or premium determination, and information related to managing such based upon the provisions of an associated plan. The data is initially stored in local database 150. The data resident in the system 110n as it pertains to CDS contract terms and conditions of a contingency payment determination may be pushed from system 110n to the server 130 on a scheduled basis or it may be pulled by server 130 depending on efficiencies determined by those skilled in the art of computer and network programming.

In one embodiment of the invention, the CDS contract does not come into existence, unless and until the litigant rejects an offer to resolve or settle the litigation for an amount which would allow full repayment of all then litigation loans due to the protection purchaser. This is a condition precedent for each CDS contract under such embodiment.

Once such offer is rejected by the litigant, the contract is created. Under such contract the credit event is then (1) the full dismissal of the litigation for which the loan has been made and (2) insufficient recovery obtained through such litigation to repay the loan(s). The credit exposure is that portion of the loan(s) which are not able to be repaid out of the proceeds, if any, of the case, limited to a maximum credit exposure amount equal to the full sum of the underlying loans or notes on said case.

In this invention, the credit event is the finality of the litigation with less than adequate recovery to shield the lender of the litigation funding protection from a financial loss.

Under one embodiment of the invention, in the event of a credit event, and the CDS seller owes the buyer the protection sought, such payment would not be due until a date certain, such as by way of example, the first November 1st following the presentation of the contract for settlement. And under a further embodiment, the buyer is required to present the instrument for settlement within a set period, say 30 days, of the credit event. This allows the seller to maintain knowledge of total settlements sought at any one time.

In regards to the valuation metric, or payoff amount, to be received by the protection buyer in the event of a credit event, this metric is based on a formula which considers the following factors: the total number of CDS contracts and notional value of same during a prior set period which encompassed the date on which the subject contract was entered into; the historical credit event occurrence rate which all instruments had experienced over time; the estimated number of CDS contracts and notional value thereof of all contracts estimated to mature during an interval, such as by way of example, the same November 1st through November 31st period, in which the contract was presented for settlement; and the pooling aspects and tranches of such in the event such method is used in the invention. Such accounting would be performed automatically at the end of the November 1st period.

Based on the assumed credit event occurrence rate, and notional value of such contracts, a payment fund shall be maintained out of which all contracts in which credit events occurred and were presented for settlement would be settled on November 1st of each year. Depending upon the credit event occurrence rate, it is possible that all contracts presented for settlement would not be paid the full notional value of the case expenses sought.

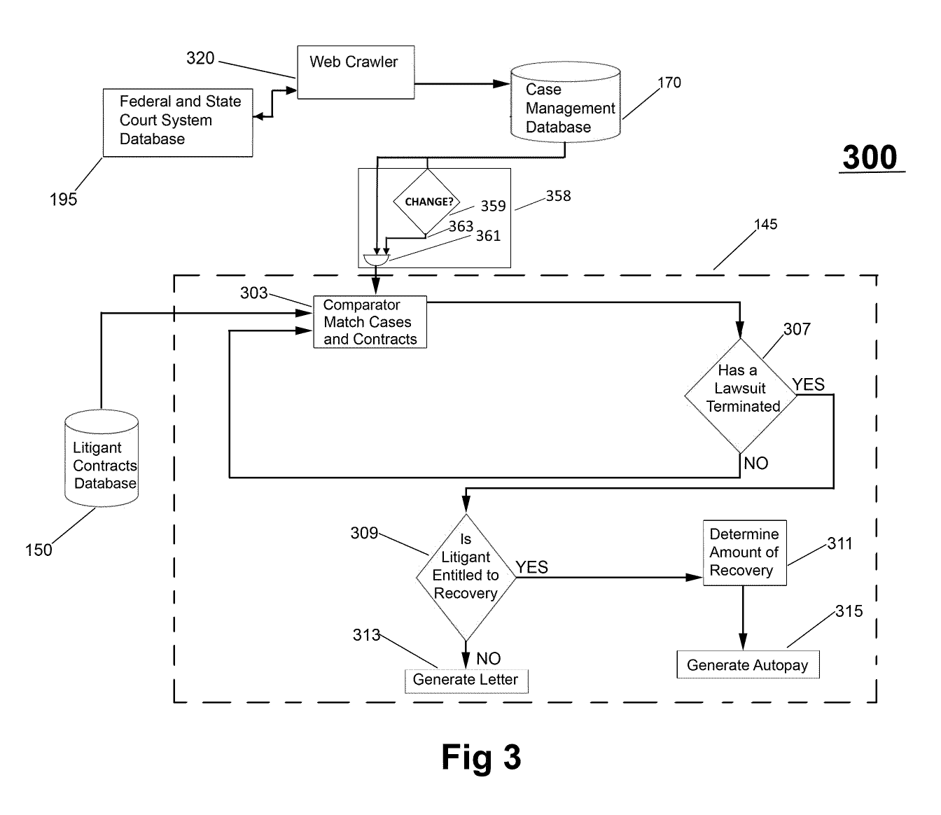

FIG. 3 represents a non limiting embodiment of the present invention that relates to a system 300 for processing data relating to reimbursing litigation expenses. The first storage device 150 stores a database that contains a plurality of indemnification contracts associated with on-going litigation. A computer processor, such as FIG. 1, server 140 as processing relates to CPU 145 and memory 148, in one embodiment, implements coding and decoding employing the principles of the present invention, when configured to: administer, by a lender, a contract, such as a CDS contract, and data related to reimbursement expenses for the on-going litigation. The second storage device 170 stores a database that contains the status of active litigation cases before state and federal courts database, where the status updated by a data input technology, such as a web crawler 320. The input technology interrogates a plurality of distributed databases 195 that monitors litigation cases before state and federal courts and sends that information to case management database 170, to keep the database updated. A data input technology 358 determines if the latest update case management database storage device 170, has changed from the previous update. And if there is a change, then the particular data under review in database 170 is transmitted to comparator 303, which compares the first database 150 information, i.e., one of the cases in database 150, to the status of that case in database 170. If the status indicates that the case has terminated (i.e., the court has rendered judgment), then the system determines if a payment for litigation expenses is due. In one non limiting embodiment, a built in delay in payment, i.e., no less than 30, no more than 90, in which payment is triggered. Since in most cases, a judgment is not final until the time for appealing the judgment is past, the system may not pay out until the appeal period has passed.

More particularly, FIG. 3 illustrates computer system 300 that determines, based on a repository of litigant contracts in database 150, and subsequent data from a litigation website such as PACER, whether a case has reached a final disposition and if so whether a recovery of litigation expenses is due. The files of litigant contracts 150, which contingently reimburse for litigation expenses, are assembled from the contract data and other information generated, as per FIG. 2.

The web crawler 320 starts with a list of URLs to visit, called the seeds. Crawl and search software 320 may also provide the crawled content and associated metadata (such as URL of the content, type of page, time of crawl, and so forth). As the crawler visits these URLs, it identifies all the hyperlinks in the page and adds them to the list of URLs to visit, called the crawl frontier. URLs from the frontier are recursively visited according to a set of policies. If the crawler is performing archiving of websites it copies and saves the information as it goes. The archives are usually stored in a database, such as case management database 170, in such a way they can be viewed, read and navigated as they were on the live web, but are preserved as ‘snapshots’.

The crawler 320 disclosed herein crawls databases such as PACER. Because most judicially created papers are published in PDF formats, such kind of crawler is particularly interested in crawling PDF, PostScript. Identifying whether these documents are legally related to a judgment or not is challenging and can add a significant overhead to the crawling process, so this may be performed as a post crawling process using machine learning or regular expression algorithms. Other crawlers may download plain text and HTML files, that contains metadata of legal documents, such as motions, decisions and judgment of the court.

Turning back to the web crawler 320, it searches various databases that service and retain information concerning ongoing litigation, as indicated by way of example, PACER state and local litigation databases, for the parameters of an outstanding lawsuit. Such parameters include litigants, type of case, date of service, litigation scheduling, motions, and dispositions including judgments and damage awards if any. Types of systems are the Federal Judiciary Case Management/Electronic Case Files (CM/ECF) system, and the related PACER (acronym for Public Access to Court Electronic Records) system. PACER is an electronic public access service of United States federal court documents. (See, http://pacer.psc.uscourts.gov/).

Pacer allows users to obtain case and docket information from the United States district courts, United States courts of appeals, and United States bankruptcy courts. The system is managed by the Administrative Office of the United States Courts in accordance with the policies of the Judicial Conference, headed by the Chief Justice of the United States. As of 2013, it holds more than 500 million documents. Other non-profit projects have begun to make such documents available online for free. These systems update the system 300 or system 100, federal and state court database 195 and/or the case management database 150.

An status change indicator 358, which includes an interface and a processor, (see, FIG. 3, FIG. 4) determines if the status in a case has changed. The automatically generated electronic indicator 363 of a change in case status received by the case management database 150 litigation file, may be provided A Specific Integrated Circuit (ASIC), that provides known outputs in response to known inputs to provide among other things, for the electronically triggered by the occurrence of a status change in the case (see, FIG. 2, 260 and FIG. 4, 358). The files in database 150 are compared in comparator 303, using machine learning or regular expression algorithms, to files resident in the case management database 170, that indicate the present litigation status of cases before various federal and state courts.

The data input technology 358 interface receives data from the case management database 170, from which the data input technology 358 determines if a case status has changed, and if the case status has changed, it then initiates a signal that allows the new data (typically a file or paper generated by the court) to be compared via the comparator 303 (see, FIG. 3) to litigants contracts 150 to determine if the new data pertains to a litigant contract of interest, as previously described. Thereafter via decision block 307, the process determining if the case achieved a final judgment, and may be ready for a payout.

As state above, when a status change has occurred, it is compared to cases on file, and if signaled by comparator 303, then test 307 determines if the case status change denotes that the case has terminated, in accordance with the litigant contracts in database 150, which under the conditions of the contract contingently reimburse for litigation expenses. If the case has not terminated then the comparator 303 reverts to a wait state, that is, continues to seek a status change to the cases in database 170, denoting that a status change in a case has occurred. If a case has terminated, as determined by test block 307, then block 309 determines, based on the litigant contracts in database 150, if reimbursement for litigation expenses is due.

In one embodiment, comparing the database litigation case to a litigant contracts database containing a related litigation case produces an electronic indicator signal, such that if the comparison matches then, the comparator stores a flag in a register. The flag is then read by a processor such as containing the test 307 that executes computer code to test if an insured is entitled to a sum of money equivalent to the value of an insured interest.

If the litigant/indemnitee is not entitled to recovery, the system 300 automatically generates a letter 313, and either mails it through the post, sends it private delivery service, or sends out an email to the litigant/indemnitee. Thereafter the process ends for the particular litigant/indemnitee, who may have purchased a contract for contingently reimbursing for litigation expenses. If the litigant/indemnitee is entitled to recovery the system 300 automatically determines in block 311, the amount of recovery, and thereafter generates an autopay event 315, and deposits a check or transfers funds in favor of the litigant/indemnitee.

Turning to FIG. 4, another embodiment of the invention includes an apparatus 400 for processing data relating to reimbursement of litigation expenses associated with a litigation case which includes: (a) a first computer interface 350, associated with litigant contracts database 150 (See, FIG. 3), to post an indemnification contract terms and conditions, related to a contingency payment in the event of a claim event as defined by one of an indemnification policy or bond; (b) a second computer interface 352 for allowing the potential insurer or lender to adjust a premium or price respectively, for its indemnification contracts dependent on one of an increase or decrease in the contingency payment; (c) a third computer interface 354 for allowing for a potential indemnitee to view a posted cost or price, and request a contract be offered at the posted price; (d) a fourth computer interface 356 for allowing the lender to offer the contract to the potential indemnitee at said posted premium dependent on at least a specified recovery amount in the future was less than or equal to at least a fixed percentage of the expenses having been advanced over the premium, by an insured, towards cost and expenses, in a litigation, and the amount advanced was not completely unrecoverable from the litigation proceeds.

The data input technology 358 previously described (see, FIG. 3, FIG. 4) includes a test 359 to determine if there is a change, such change providing an electronic indicator 363, such as a signal or flag to logic block 361, that then allows the data pertaining to the case name, docket number or other identifying information to be compared in compared 303, to whether a like case resided in the litigant contracts database 150. If there is a match, then the process determines if the data represents that the lawsuit has terminated.

The apparatus 400 in one embodiment includes a processor 310 with an appropriate interface, that performs the comparator function 303, as well as the test to determine if the lawsuit terminated 307, i.e. for determining if the litigation reached final judgment. A Specific Integrated Circuit (ASIC), that provides known outputs in response to known inputs to provide among other things, for the contingency payment may be utilized to perform the comparator function 303, and the related test 307.

If final judgement is rendered, then the apparatus 400 via processor 312, executes the function whether the litigant is entitled to recovery 309, determining the amount of recovery 311, and generating letters 313 and generating autopay 315 regarding automatically paying an amount of money dependent on the CDS contract.

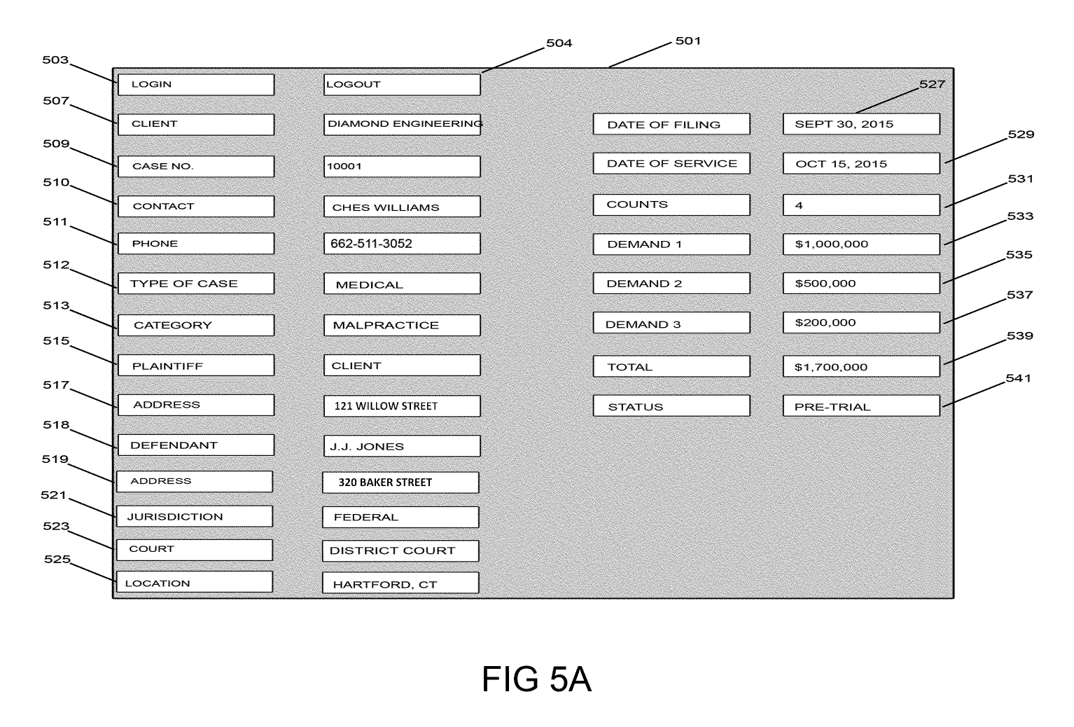

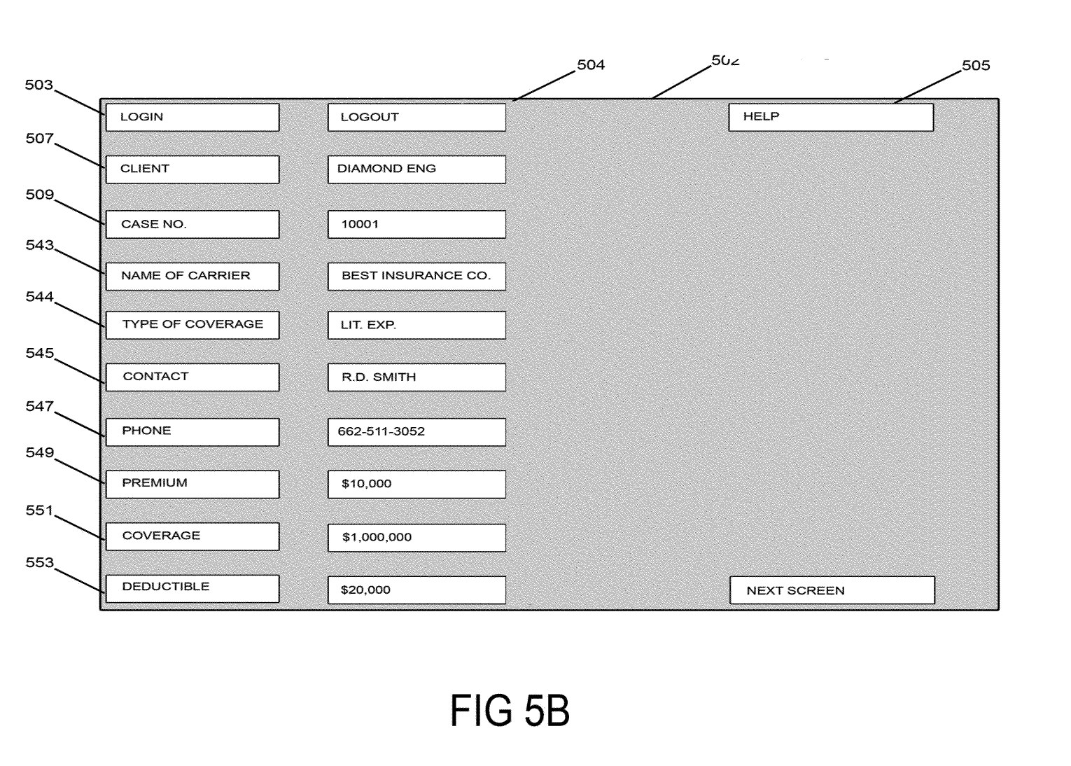

FIG. 5A and FIG. 5B illustrate a non limiting example of an application that serves as part of the statistical input data required by the process 200, as detailed in FIG. 2, and the systems FIG. 1 and FIG. 3. FIG. 5A shows a GUI screen 501 of display 103 (FIG. 1) of an application wherein a non limiting example of images generated, such as a sub-windows, log-in 503, log-out 504, and help 505 allow a user to populate the information required to carry out the eventual reimbursement to a litigant involved in a legal action that may exact costs and expenses during its prosecution or defense.

The log in screen 503 may in turn pull-up other screens to input username and passwords. Other sub-windows utilized in FIG. 5A are populated by a user inputting such items a client name 507, case number 509, contact 510, phone 511, type case 512, category 513, plaintiff 515, plaintiff address 517, defendant 518, defendant address 519, jurisdiction 521, court 523, location 525, date of filing 527, date of service 529, counts 531, demand 1, 533, demand 2 535, demand 537, total demand, 539 and status 541.

FIG. 5B, represents screen 502 of display 103 (FIG. 1) the information related to the contract coverage, such as the name of an lender 543, contact name 545, phone number 547, the premium 549, coverage 551 and the deductible 553.

While specific embodiments of the invention have been described in detail, it will be appreciated by those skilled in the art that various modifications and alterations would be developed in the overall teachings of the disclosures. Accordingly, the particular arrangement discloses are meant to be illustrative only and not limited as to the scope of the invention which is to be given the full breadth of the appended claims and in any and all equivalents thereof.

I claim:

1. A computer method for searching and retrieving of documents in a computer network to pay a non recourse loan comprising: (a) receiving from a user, through an input device, a query for a non recourse loan; guiding the user through a series of graphical user interface queries to supply information to a database about a litigation case; (b) processing the query to extract one or more of: an identity of a litigant, type of litigation case, a range of economic damages, name of insurance carriers, type of coverage; (c) the non recourse contract amount, an estimate of the time to conclude the case, a court in which the case resides, an estimate of litigation success; performing an actuarial analysis based on one or more of: the identity of a litigant, type of litigation case, the range of economic damages, name of insurance carriers, type of coverage; (d) the non recourse contract amount, the estimate of the time to conclude the case, the court in which the case resides, the estimate of litigation success; (e) performing a search of an electronic data base, using the terms of the contract, to find a contracting party offering a non recourse contract; (f) calculating a contract premium to be paid for a non recourse loan coverage of the standard contract; obtaining a search result in the form of one or more site names, universal resource locators, web pages and documents having descriptions of one or more loan entities satisfying search criteria offering the non recourse contract terms; (g) displaying the search results to the user; (h) selecting one of the loan entities; (i) purchasing the selected loan entity contract by the user; utilizing a crawler to monitor the litigation case progress; (j) utilizing one or more of an application specific processor or executable computer code, to determining if a previous litigation case document has changed from a current litigation document; (k) wherein the change produces an electronic indicator signal if the litigation case status occurs; and (l) comparing the database litigation case that produced the electronic indicator signal, to a litigant contracts database containing a related litigation case, such that if the comparison matches then, the comparator stores a flag in a register; (m) reading the flag by the processor that executes computer code to test if an insured is entitled to a sum of money equivalent to the value of an insured interest.

2. A non-transitory computer-readable medium having stored thereon computer-readable instructions comprising: (a) computer code to form a credit default swap contract; (b) computer code to form a first market participant providing for a contingency payment electronically triggered by an occurrence of a credit event of a reference entity; (c) computer code to form a second market participant; (d) computer code for requesting the second market participant to provide a premium payment to the first market participant in exchange for the contingency payment electronically triggered by the occurrence of the credit event; (e) computer code for initiating a trade between the first and the second market participant; and (f) computer code for determining the occurrence of the credit event; (g) computer code for calculating the value of the credit default swap contract due to the second market participant; (h) computer code for utilizing a crawler to monitor the progress of the litigation, utilizing one of an application specific processor or executable computer code to compare prior litigation documents to current litigation documents related to the litigation, and dependent on the comparison, setting an electronic indicator that signals a change in the litigation case status; (i) computer code for setting a flag dependent on the comparison and (j) if the litigation reaches judgment, computer code for transferring to the second market participant a sum of money equivalent to the value of the credit default swap contract.

3. A computer system for protecting against the risk of financial losses of loans for litigation financing and includes one or more network interfaces including at least one processor; at least one memory; and a computer program stored in a computer readable storage medium, executable by at least one processor comprising: (a) a first computer interface to post a first participant credit default swap contract terms and conditions of a contingency payment related to a litigation case being offered and a credit event as defined by a first participant; (b) a second computer interface for allowing the first participant to post a requested premium for the credit default swap contract; (c) a third computer interface for allowing for a second market participant to view the posted premium, and request a credit default swap contract be offered at the posted premium; (d) a fourth computer interface for allowing the first participant to offer said credit default swap contract to the second participant at said posted premium; (e) a match engine for executing the credit default swap contract between the first and the second participant; (f) a crawler to update a litigation database; (g) an electronic indicator that signals a change in the litigation case status received by a database litigation file; (h) a comparator, which compares the database litigation file data to a litigant contracts database; (i) a register for setting a flag, if the comparison matches, (j) a processor to execute code to determine if the litigation case has terminated and if a payment under the credit default contract terms and conditions of a contingency payment related to the litigation is due.

4. The system of claim 3, further including a crawler to crawl at least one litigation database.

5. The system of claim 3, wherein one or more types of cases, including contract, negligence, tort, and one or more specific causes of action, personal injury, wrongful death, premises liability, intellectual property infringement, is included in the data litigation cases stored in the first storage device.

6. The system of claim 3, wherein the CDS contract specifies one or more of a range of economic direct damages, a statement of non direct damages, attorneys fees demand.

7. The system of claim 3, wherein the computer processor executes computer code to transfer to the CDS contract a sum of money equivalent to the value of the insured interest.

8. The system of claim 4, wherein the crawler retrieves a litigation case document, such that a test against documents previously stored in a case management database results in a rejecting the litigation case document.

9. The system of claim 8, wherein the rejection results from no change in a parameter of interest.

10. The system of claim 9, wherein no rejection of the document is electronically indicated, and a comparison is performed between the document and a litigation document stored in a database.

11. The system of claim 3 further includes programs to determine the actuarial data and associated risks of particular non recourse loans.

12. The system of claim 3 further includes programs to associate three (3) parties: (a) the litigant, (b) a lending institution, and (c) a guarantor of the credit default swap contract for the repayment of the loan.

13. The system of claim 3 further includes a credit default contract is offered for sale, backed by a protection seller through one of a broker or a trading system.

14. The system of claim 3 further includes a loan document that forms an express agreement by the litigant to allow the lender to purchase the credit protection credit default swap, with such purchase price being added to a loan price as a fee or portion of an interest.
